(19) United States
(12) Patent Application Publication
(10) Pub. No.: US 2017/0122008 A1
(43) Pub. Date: May 4, 2017

(54) SAFETY LOCKING MECHANISM FOR LOCKSET

(71) Applicants: HAO MIN, NANJING (CN); ZHANGPING GONG, NANJING (CN)

(72) Inventors: HAO MIN, NANJING (CN); ZHANGPING GONG, NANJING (CN)

(21) Appl. No.: 15/310,657

(22) PCT Filed: Nov. 12, 2014
(86) PCT No.: PCT/CN2014/090933

§ 371 Date: Nov. 11, 2016

(30) Foreign Application Priority Data
May 19, 2014 (CN) 201420252710.9

(51) Int. Cl. E05B 65/00; E05B 17/20

(52) U.S. Cl. CPC E05B 65/0082; E05B 17/208

(57) ABSTRACT

The present invention relates to a safety locking mechanism for a lockset having a cover plate, a support plate, and a lock body. The safety locking mechanism includes a locking push rod having a direction-limiting shaft and a cylindrical rod, a locking stopper, and a locking compression spring. The direction-limiting shaft is mounted at one end of the cylindrical rod and the other end of the cylindrical rod passes through the support plate and presses against the cover plate. The locking stopper is rotatably mounted on the cylindrical rod and has a front end and a back end being close against the support plate and the lock body respectively. The lock body is provided with a direction-limiting groove. The direction-limiting shaft is mounted in the direction-limiting groove. The locking compression spring is mounted between the direction-limiting shaft and a bottom end of the direction-limiting groove in a compressed manner.

### FIELD

The present invention relates to the technical field of lockset safety, and more particularly to a safety locking mechanism for a lockset.

### BACKGROUND

When a current strongbox lockset is mounted, a door of a strongbox needs to be provided with a through hole for a connection line or a transmission shaft to pass through. If an input unit outside the door of the strongbox is removed, a thin rod can strike the lockset or a lock case after passing through the through hole on the door of the strongbox, such that a relatively weak portion of the lockset is knocked off. In this way, the lockset is possibly opened technically.

Most existing locksets have such a problem that if a lockset is struck from the outside of a door of the strongbox, both a dial and a cover plate inside the lockset may be knocked off, resulting in a hidden danger of technical unlocking.

### SUMMARY

The axial movement of the locking stopper is limited.

In view of the disadvantages of the prior art, the present invention provides a safety locking mechanism, in which a component of a lockset would lock a lock mechanism in the lockset when a lock cover is knocked off.

To achieve the aforementioned objective, the present invention employs the following technical solution: a safety locking mechanism for a lockset is provided, the lockset including a cover plate and a lock body, and the safety locking mechanism including a locking push rod, a locking stopper, and a locking compression spring, where the locking push rod includes a direction-limiting shaft and a cylindrical rod, where the direction-limiting shaft is mounted at one end of the cylindrical rod, the cylindrical rod is provided with a helical inclined surface at a position close to the direction-limiting shaft, the helical inclined surface protruding from the cylindrical rod and axially extending along the cylindrical rod, and the other end of the locking push rod presses against the cover plate.

The locking stopper is provided with a specially-shaped hole, the locking stopper is rotatably mounted on the cylindrical rod, a front end of the helical inclined surface is inserted into the specially-shaped hole, and when axially moving in the specially-shaped hole, the helical inclined surface drives the locking stopper to rotate only in a radial direction.

The lock body is provided with a direction-limiting groove having the same cross-sectional shape as the direction-limiting shaft, the direction-limiting shaft is mounted in the direction-limiting groove and is close against a periphery of the direction-limiting groove, the direction-limiting shaft is slidable in the direction-limiting groove only in an axial direction, and the locking compression spring is mounted between the direction-limiting shaft and a bottom end of the direction-limiting groove in a compressed manner.

Further, the lockset further includes a support plate, and a front end and a back end of the locking stopper are close against the support plate and the lock body respectively.

Further, an inner surface of the specially-shaped hole is a helical surface fit with the helical inclined surface, and when the helical inclined surface passes through the specially-shaped hole, the helical surface is driven by the helical inclined surface.

Further, after the cover plate is separated from the locking push rod, the locking push rod is elevated by the locking compression spring, the locking push rod axially moves forward, and the specially-shaped hole is driven by the helical inclined surface, thereby driving the locking push rod to rotate radially.

Further, when the support plate presses against the cover plate, the locking stopper is located outside a moving passage of a locking shaft of the lockset.

Further, when the cover plate is separated from the support plate, the locking stopper rotates to an intersection with a moving passage of a locking shaft of the lockset.

Further, the direction-limiting shaft is fixed at one end of the locking push rod, and the other end of the locking push rod passes through the specially-shaped hole of the locking stopper and the support plate in order, and closely presses against the cover plate.

Further, the locking shaft is used to control locking and rotation of a lock tongue of the lockset.

Further, the cross-sectional shape of the direction-limiting shaft is a polygon.

Further, the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

The beneficial effects of the present invention are as follows:

The present invention provides a safety locking mechanism in which a component of a lockset would lock a lock mechanism in the lockset when a lock cover is knocked off, such that the difficulty of technical unlocking is greatly increased and the lockset safety is improved; meanwhile, the present invention is simple in structure and ingenious in design while achieving an unexpected safety effect.

### BRIEF DESCRIPTION OF THE DRAWINGS

FIG. 1 is a schematic view of a locking push rod and a locking stopper of a safety locking mechanism according to the present invention;

FIG. 2 is an oblique view of the locking push rod and the locking stopper of the safety locking mechanism according to the present invention;

FIG. 3-1 is a schematic structural view of the safety locking mechanism during normal work of a lockset; and FIG. 3-2 is a schematic structural view after separation of a cover plate of the lockset; and

FIG. 4-1 is a schematic view of positions of the locking stopper and a locking shaft during normal work of the lockset; and FIG. 4-2 is a schematic view of positions of the locking stopper and the locking shaft during separation of the cover plate of the lockset.

### DETAILED DESCRIPTION

In order to make the objectives and technical solutions of the embodiments of the present invention clearer, the technical solutions of the embodiments of the present invention are clearly and completely described below with reference to the accompanying drawings of the embodiments of the present invention. It is obvious that the described embodiments are merely a part rather than all of the embodiments of the present invention. Based on the embodiments of the present invention, all other embodiments derived by persons of ordinary skill in the art without creative effort shall fall within the protection scope of the present invention.

Persons skilled in the art can understand that, unless otherwise defined, all terms (including technical and scientific terms) used herein have the same meaning as commonly understood by persons of ordinary skill in the art. It should be further understood that, terms, such as those defined in commonly used dictionaries, should be understood as having a meaning consistent with their meaning in the context of the prior art, and will not be interpreted in an idealized or overly formal sense unless expressly so defined herein.

The term “and/or” in the present invention means that either or both elements may be present.

The terms “inner and outer” in the present invention refer to, relative to a device itself, a direction toward the interior of the device and an opposite direction respectively and are not intended to specifically limit the apparatus and mechanism of the present invention.

The terms “left and right” in the present invention refer to, when a reader is facing the drawing, the left side of the reader and the right side of the reader respectively and are not intended to specifically limit the apparatus and mechanism of the present invention.

The term “connection” in the present invention may refer to direct connection between components or indirect connection between the components through other components.

The terms “clockwise” and “anticlockwise” in the present invention refer to a clockwise direction and an anticlockwise direction shown in the accompanying drawings respectively, are defined for helping the reader to read and understand, and are not intended to specifically limit the apparatus and mechanism of the present invention.

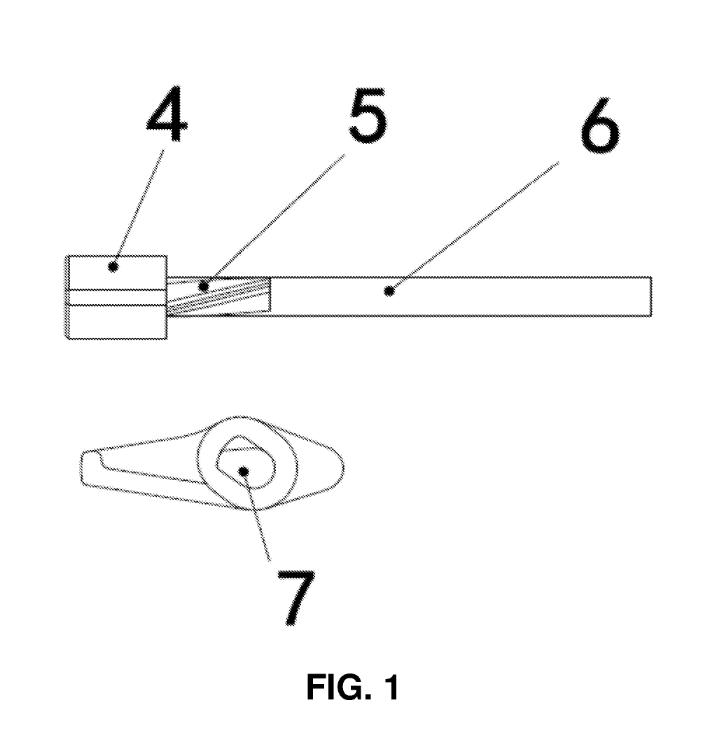

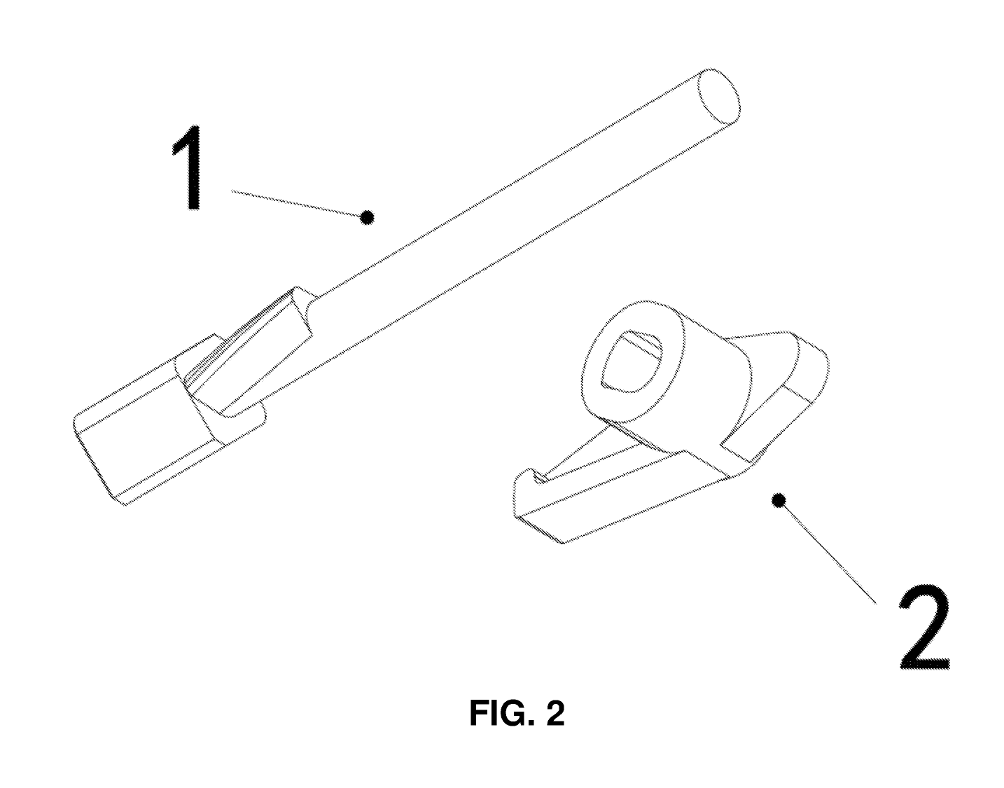

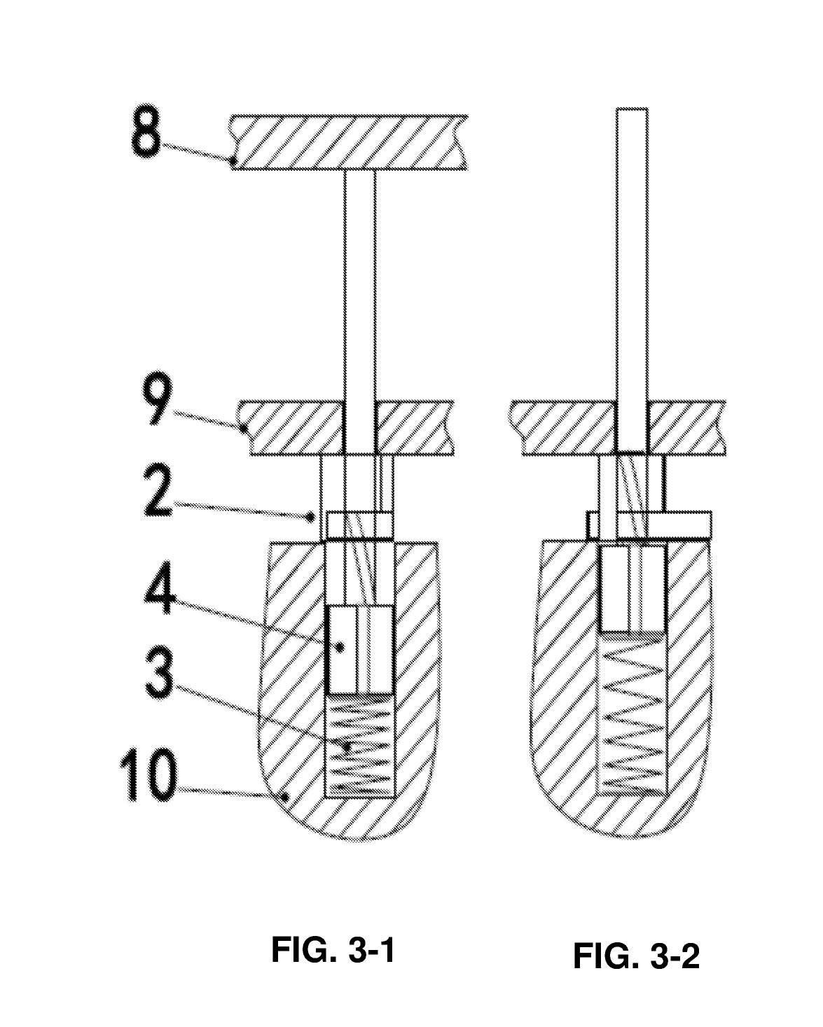

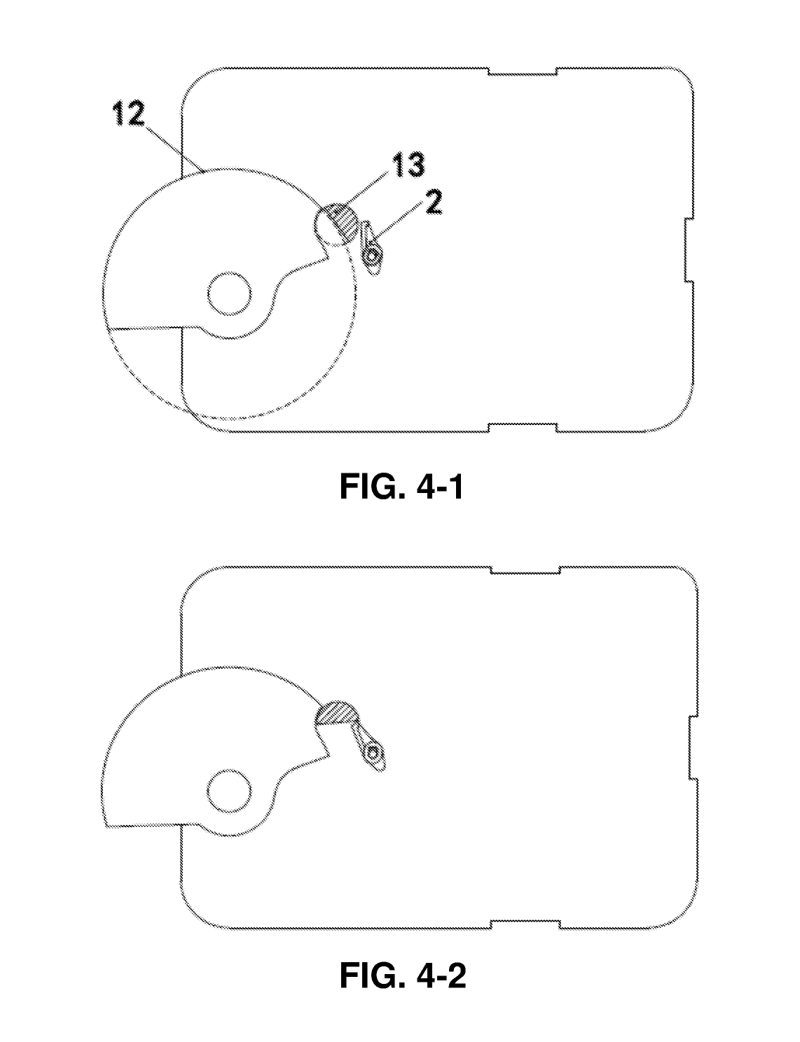

FIG. 1 is a schematic view of a locking push rod and a locking stopper of a safety locking mechanism according to the present invention; FIG. 2 is an oblique view of the locking push rod and the locking stopper of the safety locking mechanism according to the present invention; FIG. 3-1 is a schematic structural view of the safety locking mechanism during normal work of a lockset; FIG. 3-2 is a schematic structural view after separation of a cover plate of the lockset; FIG. 4-1 is a schematic view of positions of the locking stopper and a locking shaft during normal work of the lockset; and FIG. 4-2 is a schematic view of positions of the locking stopper and the locking shaft during separation of the cover plate of the lockset.

As shown in FIG. 1 to FIG. 3, a safety locking mechanism for a lockset is provided. The lockset includes a cover plate 8, a support plate 9, and a lock body 10. The safety locking mechanism includes a locking push rod 1, a locking stopper 2, and a locking compression spring 3. The locking push rod 1 includes a direction-limiting shaft 4 and a cylindrical rod 6. The direction-limiting shaft 4 is mounted at one end of the cylindrical rod 6. The cylindrical rod 6 is provided with a helical inclined surface 5 at a position close to the direction-limiting shaft 4, the helical inclined surface 5 axially extending along the cylindrical rod 6, as shown in FIG. 3-1, and the other end of the locking push rod 1 passes through the support plate 9 and presses against the cover plate 8. The locking stopper 2 is provided with a specially-shaped hole 7, the locking stopper 2 is rotatably mounted on the cylindrical rod 6, a front end of the helical inclined surface 5 is inserted into the specially-shaped hole 7, the specially-shaped hole 7 is driven by the helical inclined surface 5, and a front end and a back end of the locking stopper 2 are close against the support plate 9 and the lock body 10 respectively. The lock body 10 is provided with a direction-limiting groove, the direction-limiting shaft 4 is mounted in the direction-limiting groove and is close against a periphery of the direction-limiting groove, and the locking compression spring 3 is mounted between the direction-limiting shaft 4 and a bottom end of the direction-limiting groove in a compressed manner.

As shown in FIG. 3-2 of FIG. 3, after the cover plate 8 is separated from the locking push rod 1, the locking push rod 1 is elevated by the locking compression spring 3, and the locking push rod 1 axially moves forward. When the locking push rod 1 axially moves forward, the specially-shaped hole 7 is driven by the helical inclined surface 5, thereby driving the locking push rod 1 to rotate radially.

As shown in FIG. 4-1, when the support plate 9 presses against the cover plate 8, the locking stopper 2 is located outside a moving passage of a locking shaft 11 of the lockset. As shown in FIG. 4-2, when the cover plate 8 is separated from the support plate 9, the locking stopper 2 rotates to an intersection with the moving passage of the locking shaft 11 of the lockset.

The direction-limiting shaft 4 is fixed at one end of the locking push rod 1. The other end of the locking push rod 1 passes through the specially-shaped hole 7 of the locking stopper 2 and the support plate 9 in order, and closely presses against the cover plate 8. The locking shaft 11 is used to control locking and rotation of a lock tongue 12 of the lockset.

The cross-sectional shape of the direction-limiting shaft may be a polygon, for example, a triangle or a quadrangle.

The direction-limiting shaft may also be a circular shaft, the circular shaft being provided with an axial key groove. A limiting key fit with the key groove is fixed on an inner wall of the direction-limiting groove. The limiting key is slidable in the key groove in an axial direction.

The implementations of the present invention are specifically described in detail, but they are not to be construed as limiting the scope of the present invention. It should be noted that, several modifications and improvements can be made by persons of ordinary skill in the art without departing from the concept of the present invention. All these modifications and improvements are within the protection scope of the present invention.

1. A safety locking mechanism for a lockset, the lockset comprising a cover plate and a lock body, wherein the safety locking mechanism comprises a locking push rod, a locking stopper, and a locking compression spring, wherein,
the locking push rod comprises a direction-limiting shaft and a cylindrical rod, wherein the direction-limiting shaft is mounted at one end of the cylindrical rod, the cylindrical rod is provided with a helical inclined surface at a position close to the direction-limiting shaft, the helical inclined surface protruding from the cylindrical rod and axially extending along the cylindrical rod, and the other end of the locking push rod presses against the cover plate;
the locking stopper is provided with a specially-shaped hole, the locking stopper is rotatably mounted on the cylindrical rod, a front end of the helical inclined surface is inserted into the specially-shaped hole, and when axially moving in the specially-shaped hole, the helical inclined surface drives the locking stopper to rotate only in a radial direction; and
the lock body is provided with a direction-limiting groove having the same cross-sectional shape as the direction-limiting shaft, the direction-limiting shaft is mounted in the direction-limiting groove and is close against a periphery of the direction-limiting groove, the direction-limiting shaft is slidable in the direction-limiting groove only in an axial direction, and the locking compression spring is mounted between the direction-limiting shaft and a bottom end of the direction-limiting groove in a compressed manner.

2. The safety locking mechanism for a lockset according to claim 1, wherein the lockset further comprises a support plate, and a front end and a back end of the locking stopper are close against the support plate and the lock body respectively.

3. The safety locking mechanism for a lockset according to claim 1, wherein an inner surface of the specially-shaped hole is a helical surface fit with the helical inclined surface, and when the helical inclined surface passes through the specially-shaped hole, the helical surface is driven by the helical inclined surface.

4. The safety locking mechanism for a lockset according to claim 3, wherein after the cover plate is separated from the locking push rod, the locking push rod is elevated by the locking compression spring, the locking push rod axially moves forward, and the specially-shaped hole is driven by the helical inclined surface, thereby driving the locking push rod to rotate radially.

5. The safety locking mechanism for a lockset according to claim 1, wherein when the support plate presses against the cover plate, the locking stopper is located outside a moving passage of a locking shaft of the lockset.

6. The safety locking mechanism for a lockset according to claim 1, wherein when the cover plate is separated from the support plate, the locking stopper rotates to an intersection with a moving passage of a locking shaft of the lockset.

7. The safety locking mechanism for a lockset according to claim 1, wherein the direction-limiting shaft is fixed at one end of the locking push rod, and the other end of the locking push rod passes through the specially-shaped hole of the locking stopper and the support plate in order, and closely presses against the cover plate.

8. The safety locking mechanism for a lockset according to claim 7, wherein the locking shaft is used to control locking and rotation of a lock tongue of the lockset.

9. The safety locking mechanism for a lockset according to claim 1, wherein the cross-sectional shape of the direction-limiting shaft is a polygon.

10. The safety locking mechanism for a lockset according to claim 1, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

11. The safety locking mechanism for a lockset according to claim 2, wherein the cross-sectional shape of the direction-limiting shaft is a polygon.

12. The safety locking mechanism for a lockset according to claim 3, wherein the cross-sectional shape of the direction-limiting shaft is a polygon.

13. The safety locking mechanism for a lockset according to claim 4, wherein the cross-sectional shape of the direction-limiting shaft is a polygon.

14. The safety locking mechanism for a lockset according to claim 2, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

15. The safety locking mechanism for a lockset according to claim 3, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

16. The safety locking mechanism for a lockset according to claim 4, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

17. The safety locking mechanism for a lockset according to claim 5, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

18. The safety locking mechanism for a lockset according to claim 6, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

19. The safety locking mechanism for a lockset according to claim 7, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.

20. The safety locking mechanism for a lockset according to claim 8, wherein the direction-limiting shaft is a circular shaft, the circular shaft is provided with an axial key groove, a limiting key fit with the key groove is fixed on an inner wall of the direction-limiting groove, and the limiting key is slidable in the key groove in the axial direction.
